(19) United States
(12) Patent Application Publication
(10) Pub. No.: US 2022/0206279 A1
(43) Pub. Date: Jun. 30, 2022

(54) MICROSCOPY ILLUMINATION APPARATUS, METHODS, AND APPLICATIONS

(71) Applicant: UNIVERSITY OF CENTRAL FLORIDA RESEARCH FOUNDATION, INC., Orlando, FL (US)

(72) Inventors: Kyu Young Han, Orlando, FL (US); Benjamin Croop, Oviedo, FL (US); Jialei Tang, San Jose, CA (US)

(73) Assignee: UNIVERSITY OF CENTRAL FLORIDA RESEARCH FOUNDATION, INC., Orlando, FL (US)

(21) Appl. No.: 17/644,278

(22) Filed: Dec. 14, 2021

Related U.S. Application Data
(60) Provisional application No. 63/131,194, filed on Dec. 28, 2020.

(51) Int. Cl. G02B 21/16; G02B 21/06; G02B 21/33; G01N 21/64

(52) U.S. Cl. CPC G02B 21/16; G02B 21/06; G01N 2021/6478; G01N 21/6458; G01N 2021/6484; G02B 21/33

(57) ABSTRACT

A method and associated apparatus for generating instantaneous and uniform total internal reflection fluorescence (TIRF) excitation. An annular fiber bundle and is used with spatially incoherent light to provide appropriate illumination matched to parameters of the back focal plane of an oil-immersion or in-air imaging objective lens, enabling quantitative shadowless TIRF imaging.

### RELATED APPLICATION DATA

The instant application claims priority to U.S. provisional application Ser. 63/131,194 filed Dec. 28, 2020, the subject matter of which is incorporated by reference in its entirety.

### GOVERNMENT FUNDING

Government funding was provided by National Institutes of Health under contract R35GM138039. The US government has certain rights in the invention.

### BACKGROUND

Non-limiting aspects and embodiments most generally pertain to the field of microscopy illumination and imaging apparatus, related methods, and applications thereof; more particularly to fluorescence microscopy illumination and imaging apparatus, methods, and applications; and, most particularly to total internal reflection fluorescence (TIRF) microscopy illumination and imaging apparatus and methods, and applications thereof.

Total internal reflection (TIRF) microscopy is a popular and useful tool for studying surface features of biological specimens and imaging single molecules with a high signal to noise ratio. When an excitation beam impinges on the glass sample interface with an incidence angle that is greater than the critical angle, the illumination beam generates an evanescent field that selectively excites fluorescently labeled biomolecules near the surface with a penetration depth of roughly 50-200 nm.

There are a variety of methods to generate TIRF excitation with the most common in cellular imaging being objective TIRF. Typically, objective TIRF is achieved by tightly focusing a single laser excitation beam to the periphery of the back focal plane (BFP) of an objective with a numerical aperture (NA) of 1.4 or greater (see FIG. 1A). However, this method can cause uneven illumination due to interference fringes from the coherent laser beam and shadowing caused by obscuring objects in cells. These issues have been mitigated via spinning TIRF where the excitation spot is rapidly rotated to various positions around the TIRF annulus of the objective within a single camera exposure (FIG. 1B) using refractive optics, piezo/galvo mirrors, acousto-optic deflectors, or a digital micromirror device. The result is an incoherent superposition of the excitation intensity from each azimuthal angle.

Alternatively, an annular mask can be placed at a plane conjugated to the BFP, so that only the TIRF annulus is illuminated and a uniform TIRF excitation field is instantly generated (FIG. 1C). This implementation is appealing due to the simplified setup with no moving parts and its compatibility with incoherent light sources; however, the use of a mask incurs significant power losses, which can be greater than 99% in some cases. Whereas uniform TIRF illumination with a higher efficiency has been proposed by generating annular beams with axicon optics, these approaches have a limited field of view (FOV), suffer from a strong zero-order spot that prevents quantitative analysis, or are difficult to implement in a commercial imaging system.

The inventors recognize the benefits and advantages of the solutions to these and other known shortcomings in the art, which solutions are enabled by the aspects and embodiments described herein below.

### SUMMARY

Exemplary, non-limiting aspects and embodiments include components, systems, and methods designed to reshape the light from an excitation source into a ring-shaped beam at the output of a fiber bundle. When the ring-shaped beam is directed to an oil-immersion imaging objective total internal reflection fluorescence (TIRF) illumination is generated. TIRF illumination is useful in quantitative fluorescence microscopy for imaging surface features with a high signal-to-background ratio. Highly inclined illumination can be achieved when the fiber bundle is used with an air objective or an additional relay system is used with an oil immersion objective. This type of illumination is advantageous when imaging three-dimensional (3D) features to minimize artifacts from back reflections while providing a uniform illumination profile.

A non-limiting embodiment is a device that reshapes the excitation light into a ring-shaped beam, which is conjugated to the back focal plane of an imaging objective. The output end of the device includes multiple single-mode or multi-mode fibers arranged around a spacer such that they form a single ring of fibers. When used with an oil-immersion objective, the size of the ring is advantageously matched to the size of the region of the back focal plane of the imaging objective that selectively contributes to TIRF excitation considering the magnification from any relay optics used. The input end may be a collection of the same single-mode or multi-mode fibers in a close-packed arrangement if a fiber bundle is used or a single large-core multi-mode fiber if a photonic lantern is used. The embodied device enables TIRF illumination with incoherent or coherent sources, provided that the coherence of the source is reduced prior to the input of the annular bundle. Here a lamp, LED, or laser can be the excitation light sources but the laser can have the highest transmission efficiency. The device requires no moving parts, provides high excitation power throughput, and can generate uniform, artifact-free TIRF illumination over a large field-of-view.

The fiber bundle can also be used with an air objective, water objective and silicone objective when TIRF illumination is not required. By conjugating the output of the fiber bundle to the periphery of the back focal plane of an air objective, highly inclined illumination is provided at the sample plane. This type of illumination is useful to prevent back reflections from a reflective sample; moreover, the annular illumination provides a uniform illumination profile that suppresses shadowing artifacts from any topographical features on the sample. This may be of use for, e.g., imaging photoluminescent semiconductor wafers with etched features where edges created by the etching process may create shadows across the feature.

Non-limiting applications include but are not limited to live-cell imaging on biomarkers near the surface, single-molecule fluorescence imaging, high-throughput large field-of-view cellular fluorescence imaging, super-resolution fluorescence imaging, inspection of photoluminescent semiconductor wafers.

### BRIEF DESCRIPTION OF THE DRAWING FIGURES

FIG. 1(a) illustrates single-spot TIRF (prior art); FIG. 1(b) illustrates variable-angle TIRF (prior art); FIG. 1(c) illustrates annular TIRF using an annular mask at a plane conjugated to the BFP of an objective (prior art); FIGS. 1(d) and 1(e), respectively, illustrate fiber bundle input and output facets using a ring of multi-mode fibers, according to a non-limiting, exemplary embodiment.

FIG. 2 schematically shows an experimental setup, FBi/o, Fiber bundle input/output; SMF, Single-mode fiber; MMF, multimode fiber; L, Lens; TL, Tube lens; M, Mirror; FM, Flip mirror; FC, Filter cube. Lower-left inset: Image of fiber bundle beam at the BFP. Scale bar, 2 mm.

FIG. 3. Demonstration of TIRF penetration depth via single-molecule imaging. Images of the same field of view taken in the presence of IOW fluorescent background using (a) URI′ and (b) epi illumination. (c) TIRF image without fluorescent background in a different field of view than in (a) and (b). (d) Intensity distributions generated from single-molecules in 20 images comparing annular TIRF and single-spot TIRF illumination. Inset: illustration of excitation penetration depth while imaging in high background. Scale bars, 5 μm,

FIG. 4. Beam characterization. Dye layer images recorded in TIRE using (a) a diode laser with a shaker motor, (b) a diode laser without the shaker motor, and (c) an LED. (d) Line profiles taken along diagonal as indicated by solid lines in (a), (c), Scale bars, 50 μm.

FIG. 5. TIRF imaging of actin in U2OS cells using (a) LED annular TIRE, (b) laser diode annular TIRE, and (c) single-spot objective TIRF. Arrow indicates direction of single-spot TIRF excitation, Scale bars, 10 μm.

FIG. 6, High-throughput stitched imaging of actin stained U2OS cells imaged under (a) TIRF and (b) epi illumination using the LED source and fiber bundle. Upper-right inset: Zoomed view of boxed region. Scale bars, 50 μm.

FIG. 7 is a schematic comparative cross sectional illustration of single-spot objective TIRE imaging in the prior art (left) and annular TIRF (right), according to an embodiment of the invention,

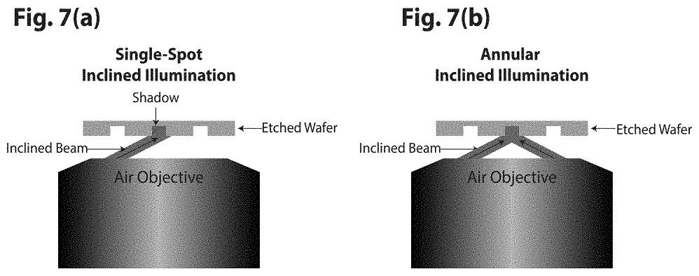

FIG. 8 is a schematic cross sectional end view of multimode fibers of a fiber bundle input (left) and a ring of multi-mode fibers disposed around a spacer of the fiber bundle output (right), according to an embodiment of the invention.

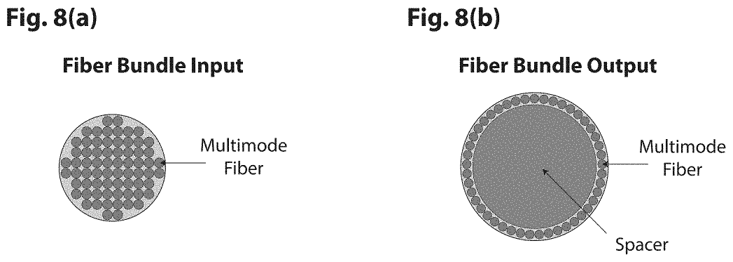

FIG. 9 is a schematic cross sectional end view of large core fiber input face (left) and a ring of multi-mode fibers disposed around a spacer of the fiber bundle output (right), according to an embodiment of the invention.

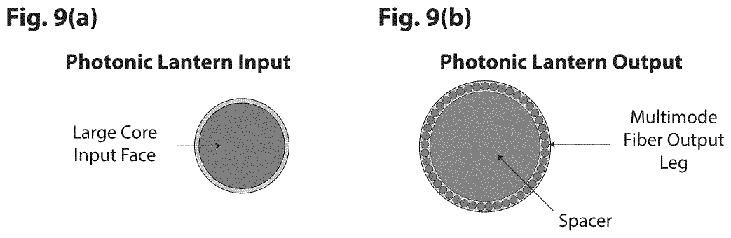

FIG. 10 is a schematic comparative cross sectional illustration of single-spot inclined illumination known in the art (left) and annular inclined illumination (right), according to an embodiment of the invention.

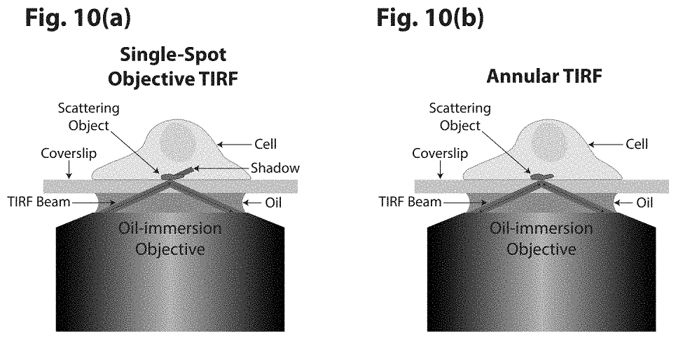

### DETAILED DESCRIPTION OF NON-LIMITING, EXEMPLARY EMBODIMENTS

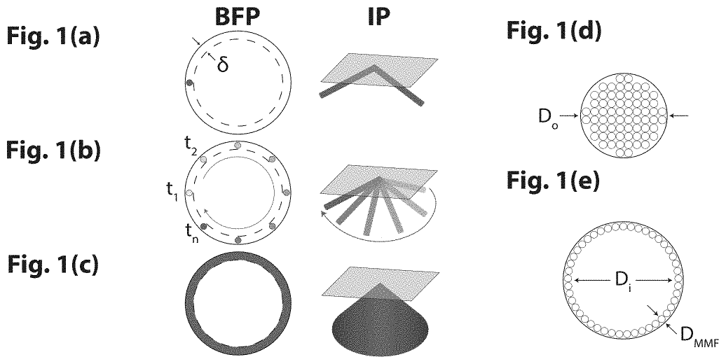

Herein below we demonstrate a novel method of generating instantaneous, uniform, and efficient TIRF by coupling an excitation source into a tailored fiber bundle. The basic concepts of the embodiment are outlined as follows: (i) the individual fibers in the bundle are arranged in a ring at the output end, which is focused and re-imaged within the TIRF annulus of the BFP of an imaging objective, and (ii) the beam exiting from each fiber is spatially incoherent such that they are incoherently summed at the image plane. FIGS. 1(d, e) show its working principle and illustrations of the input (FIG. 1(d)) and output (FIG. 1(e)) ends of the fiber bundle in comparison with single-spot (FIG. 1(a)), spinning (FIG. 1(b)), and mask-enabled (FIG. 1(c)) TIRF known in the art.

We designed the annular fiber bundle to be compatible with a 60×/NA1.45 objective (PLAPON60XOTIRFM, Olympus). Our fiber bundle consisted of 137 individual multimode fibers that were close-packed at the input end and arranged in a single ring around a spacer at the output end [FIG. 1(d)]. Considering the size of the BFP of our objective, we designed the bundle such that when the output was magnified 3× it would be relayed to the outer annular region of the BFP that generates TIRF illumination. A detailed description of the design process is given in Supplement at the end of this document.

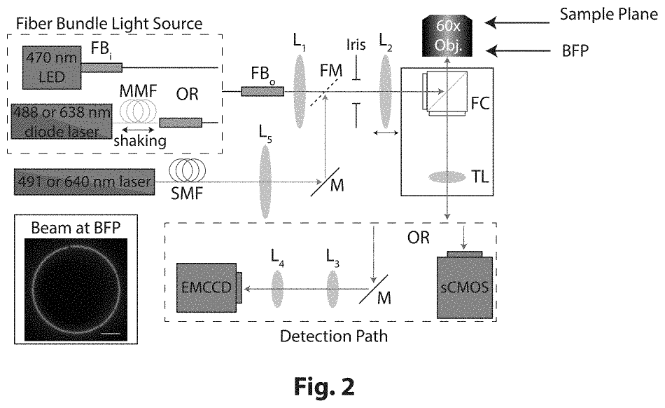

The fiber bundle was fed into a custom-made TIRF microscope built around an Olympus IX73 body (FIG. 2). The bundle output was collimated by a lens L₁(f₁=100 mm) and focused to the BFP of the objective by a lens L₂ (f₂=300 mm), which was mounted on a manual xy and motorized z translation stage. By translating L₂ one inch along the optic axis, we can change the size of the beam at the BFP to achieve TIRF or weakly focused epi illumination. The beam was reflected by a filter cube (TRF89901v2, Chroma) and the fluorescence signal was detected by a scientific complementary metal oxide semiconductor camera (sCMOS, Zyla 4.2 PLUS, Andor) or an electron multiplying charged-coupled device (EMCCD, iXon Ultra 897, Andor). The sCMOS was used to demonstrate large FOV (222×222 μm²) TIRF, but the EMCCD was used in all other experiments. An additional 1.66× magnification system was installed prior to the EMCCD for a total image magnification of 100× to satisfy the Nyquist criterion for single-molecule imaging. An image of the fiber bundle output taken at the BFP is shown in an inset of FIG. 2.

Two lasers—488 nm and 638 nm (06-MLD, Cobolt) as well as a 470 nm light emitting diode (LED, M470F3, Thorlabs), which was directly coupled via SMA connectors to the fiber bundle, were the light sources used with the fiber bundle to demonstrate multicolor imaging and TIRE with coherent or incoherent sources. The diode lasers were first coupled into a 400 μm core multi-mode fiber (MMF, M28L01, Thorlabs) that was attached to a shaker motor (JRF370-18260, ASLONG) to degrade the coherence of the beam before coupling into the fiber bundle input. For comparison with single-spot TIRF, a 491 nm or 640 nm laser (04-01 Calypso, 05-01 Bolero, Cobolt) was coupled to a single-mode fiber (P5-488PM-FC-1, Thorlabs) and collimated by a lens (f=300 mm) and directed to the microscope by a flip mirror. We observed a total power efficiency of ˜30% when using the 638 nm laser, with 76% of the total loss occurring at the coupling of the MMF into the fiber bundle. This was expected, as ˜50% of the fiber bundle input is void and the MMF was roughly butt-coupled to the fiber bundle input, with an intentional gap between the MMF and fiber bundle to compensate for the difference in their core sizes. A further optimized design will greatly mitigate the power losses.

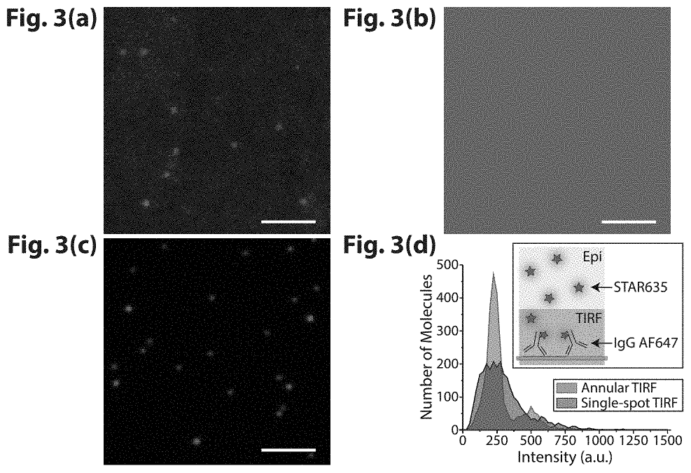

We first demonstrated the shallow excitation depth of our TIRF field using the 638 nm diode laser coupled into the annular fiber bundle. Single-molecule images were recorded of surface-immobilized IgG antibodies labeled with Alexa Fluor 647 (AF647) at a degree of labeling of ˜1.1 in the presence of 10 nM STAR635 diluted in an imaging buffer as fluorescent background. Our result shows that the single molecules are able to be resolved with an average signal-to-background ratio of 2.3 (n=20) when imaged in TIRE [FIG. 3(a)], whereas the background overwhelms the single-molecule signal when imaged under epi illumination [FIG. 3(b)]. Note that at this concentration of fluorescent background, even a slight degree of far-field excitation due to partial TIRF could substantially increase the background level, indicating that our annular fiber bundle produces clean TIRF excitation. The effective penetration depth was roughly 235 nm, which was estimated by measuring the diameter of 1 μm fluorescent beads (F8816, ThermoFisher). In addition, we obtained single-molecule images without fluorescent background [FIG. 3(c)] and analyzed the intensity of each spot, comparing annular and single-spot TIRF illumination. The annular TIRF intensity distribution has narrower peaks and two observable populations, while the single-spot TIRE distribution is broader and less defined [FIG. 3(d)]. This demonstrates that our annular TIRF excitation field enabled the distinction between antibodies labeled with one or two fluorophores, which is only possible with uniform excitation.

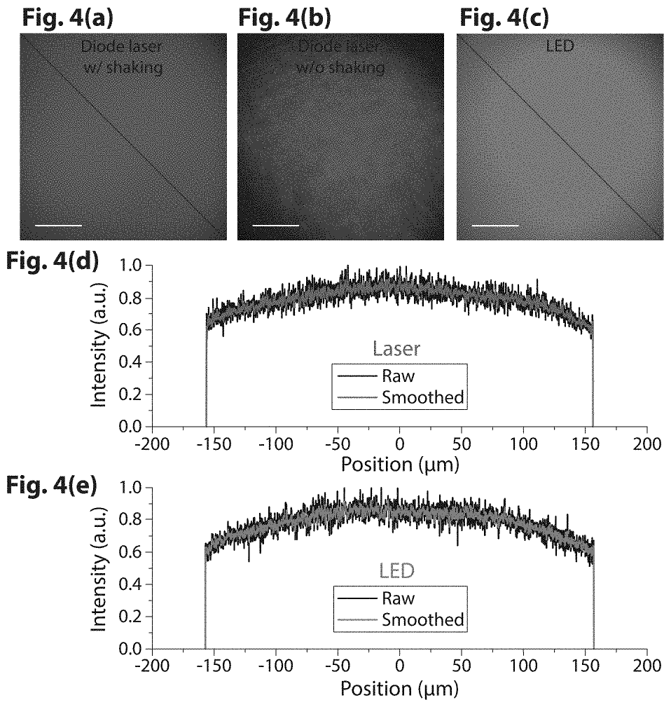

We further examined the uniformity of our illumination by measuring beam profiles taken by exciting a ˜5 μm thick dye layer (Atto488 or STAR635) sandwiched between a microscope slide and coverslip and imaged with the sCMOS detector for a 222×222 μm² FOV (FIG. 4). The uniformity was characterized by the root mean square (RMS) of the line profile intensity. Detector noise from the sCMOS degraded the RMS values of the diode laser [FIG. 4(a)] and LED [FIG. 4(c)] to 0.79 each, but after smoothing via adjacent averaging, the RMS values were 0.84 and 0.86, respectively. In the central 82×82 μm² region representing the EMCCD FOV, the respective smoothed RMS values were 0.91 and 0.92. Without shaking, the diode laser had an RMS of 0.70 before and 0.77 after smoothing. Raw and smoothed line profiles are plotted in FIG. 4(d) for the LED and diode laser with shaking.

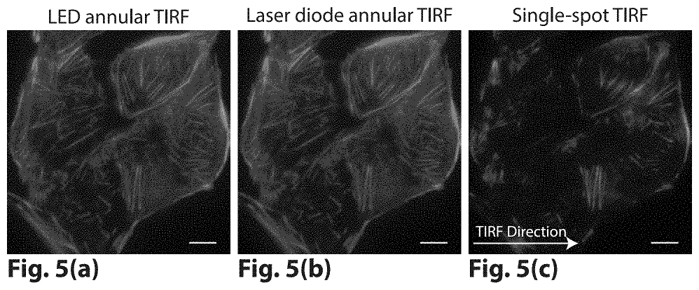

Artifacts from single-spot TIRF illumination are often more severe when imaging subcellular structures in cells. To demonstrate the homogeneity of the TIRF excitation generated by our fiber bundle, we imaged U2OS cells that were stained with Alexa Fluor 488 phalloidin (A12379, ThermoFisher) to label filamentous actin. Images taken with the 470 nm LED or 488 nm diode laser coupled with our fiber bundle are compared with single-spot TIRF. FIG. 5 shows that our annular fiber bundle generates uniform TIRF illumination for artifact-free imaging regardless of the light source, whereas single-spot ‘TIRE’ results in strong interference fringes from the excitation source, scattering and/or shadowing artifacts from the unidirectional excitation.

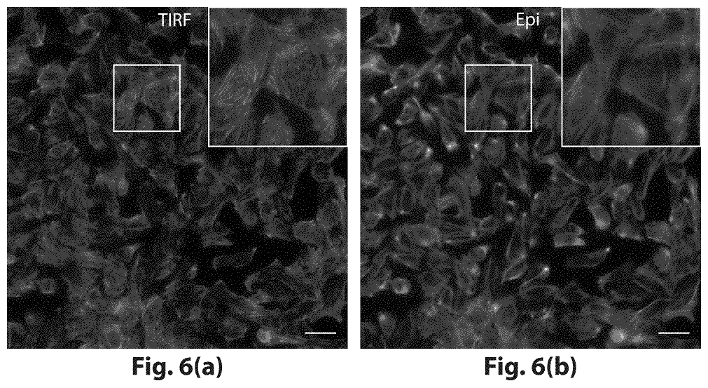

Finally, we demonstrated high-throughput stitched imaging with our annular fiber bundle using a 15% image overlap on the phalloidin stained U2OS cells to record a 550×5501 μm² area. To demonstrate the ease of switching between illumination modes, FIG. 6 shows a comparison of the same FOV taken in TIRF and epi illumination using the LED light source, where the inset shows a magnified view of the boxed region. Surface features such as focal adhesions are clearly resolved under TIRE excitation, whereas these features are less visible under epi illumination due to elevated background fluorescence from non-surface actin structures.

We have demonstrated a method of instantly achieving shadowless TIRF excitation using an annular fiber bundle. We showed that this method is suitable for multicolor imaging and generates a uniform and shallow excitation field. It is possible to use other popular TIRF objectives such as a 100×NA1.49 objective if one designs a new fiber bundle and modifies the imaging system slightly. Our annular fiber bundle was designed to be suitable with both a laser or LED; however, LED excitation has a very limited power throughput and thus is not suitable for imaging weakly fluorescent samples such as single molecules. If one only uses a laser as an excitation source, a more optimized design, for example, utilizing a shorter focal length lens L₁ and fewer MMF fibers, is likely to increase the power throughput. Versatile control of the incidence angle is possible via calibration of the motorized translation stage on L₂, which will be useful for depth-matched multi-color TIRE illumination and 3D reconstruction by multi-angle TIRF. Polarization-based TIRF experiments may be feasible by generating radially or azimuthally polarized light using a segmented half waveplate. With no moving parts, our method is compatible with video-rate live-cell TIRE imaging. We expect our method will make quantitative TIRF imaging systems more accessible.

Supplement

Detailed Fiber Bundle Design

We designed our annular fiber bundle such that it would be compatible with our 1.45 NA 60× objective (PLAPON60XOTIRFM, Olympus) when the fiber bundle output was magnified 3-fold at the back focal plane (BFP) of the objective. We first estimated the diameter of the BFP of our objective using geometric optics described by Equation 1 below:

D_{BFP}=2f_{obj}(NA) (1)

where D_{BFP} is the diameter of the BFP, f_{obj} is the focal length of the objective, and NA is the numerical aperture of the objective. For our objective we calculated that the BFP is roughly 8.7 mm in diameter. We then estimated the width of the annulus in the BFP that supports TIRF illumination, described by

δ=f_{obj}(NA−nₛₐₘₚₗₑ) (2)

where δ is the width of the TIRF annulus and nₛₐₘₚₗₑ is the refractive index of the sample, which was estimated as 1.335. From Eq. (2) we estimated the width of the TIRF annulus to be roughly 345 μm, meaning that the central 8.01 mm diameter region of the BFP contributes to epi illumination.

Our 100 mm collimating lens and 300 mm focusing lens yielded a 3× magnification of the bundle output at the BFP, which meant that our fiber bundle output should have an outer diameter of 2.9 mm. Note that the 3× magnification was used for convenience. The central 2.67 mm diameter region contributes to epi illumination, and the outermost 115 μm annulus contributes to TIRF illumination. We chose to use the 0.22 NA 50/55/65 μm multi-mode fibers (MMF) as the individual fibers in our bundle, where the diameters refer to the core/cladding/protective layers, respectively. We chose to use a slightly larger spacer than necessary, with a diameter of 2.77 mm to prevent leakage of epi illumination. This left a 65 μm annulus region that contributes to TIRF illumination and was suited to the size of the individual fibers. The MMF can have different parameters, for example, NA ranging from 0.1 to 0.5 and the core diameter ranging from 10 μm to 100 μm. In this case, the imaging magnification and oil immersion objective have corresponding parameters to generate TIRF illumination.

We packaged 137 individual fibers in the fiber bundle such that they were arranged in a single ring around the spacer at the output end, and in a close-packed arrangement at the input end. It is possible to use less number of the fibers. For example, four (4) individual fibers can generate uniform TIRF illumination although the uniformity would be not as good as when using the larger number of fibers. The input of the fiber was assembled in an SMA connector for direct coupling with compatible light sources. A summary of the fiber bundle dimensions and details are presented in Table 1, and a schematic of the fiber bundle input and output ends is shown in FIG. 1(d).

TABLE 1
Fiber Bundle Specifications

| | Fiber | Fiber |
|---|---|---|
| | input | Output |
| Number of Fibers | 137 | |
| Fiber Core/Cladding/Protective | 50/55/65 | |
| Layer Diameter (μm) | | |
| Individual Fiber NA | 0.22 | |
| Outer Diameter (mm) | ~1.1 | 2.9 |
| | (unspecified) | |
| Spacer Diameter (mm) | N/A | ~2.77 |
| Fiber Arrangement | Close- | Annular |
| | packed | |

We claim:

1. A total internal reflection fluorescence (TIRF) microscopy apparatus, comprising:
a ring illumination component having a fiber optic input end and an output end comprising a plurality of optical fibers arranged in an annulus having a diameter, D;
an imaging objective lens having a numerical aperture (NA), a focal length, and a back focal plane of the objective lens; and
a lens adapted to focus a ring of spatially incoherent light from the output end to a region of the back focal plane of the objective lens.

2. The TIRF apparatus of claim 1, wherein the ring illumination component is a photonic lantern.

3. The TIRF apparatus of claim 2, wherein the input end of the photonic lantern is a single large-core multi-mode fiber and the output end is an annular plurality of single-mode or multi-mode fibers.

4. The TIRF apparatus of claim 1, wherein the fiber optic input end comprises a plurality of single-mode or multi-mode fibers arranged in a consolidated bundle.

5. The TIRF apparatus of claim 1, wherein the imaging objective lens is an oil-immersion optic.

6. The TIRF apparatus of claim 1, wherein the lens adapted to focus a ring of spatially incoherent light from the output end to a region of the back focal plane of the imaging objective comprises a collimation lens and a movable lens.

7. The TIRF apparatus of claim 1, further comprising an input light phase scrambler adapted to provide a spatially incoherent light at the output end.

8. The TIRF apparatus of claim 1, wherein the NA of the objective is equal to or greater than 1.4.

9. A method for total internal reflection fluorescence (TIRF) microscopy, comprising:
generating a ring of spatially incoherent light sufficient to generate fluorescence emission from a sample; and
focusing the ring of spatially incoherent light onto a back focal plane of an imaging objective,
whereby light output from the objective is TIRF illumination.

10. The method of claim 9, wherein the step of generating the ring of spatially incoherent light further comprises inputting light from a coherent and/or an incoherent source to one or a plurality of optical fibers having an output arranged as a ring of a plurality of individual fibers.

11. The method of claim 9, further comprising inputting the light into a single large core fiber and outputting light from a plurality of single-mode or multimode fibers.

12. The method of claim 9, further comprising inputting the light into a closely packed bundle of multimode fibers and outputting light from a plurality of single-mode or multimode fibers.

13. The method of claim 9, further comprising focusing the ring of spatially incoherent light onto the back focal plane of an oil-immersion imaging objective.

14. The method of claim 10, further comprising inputting light from a coherent source and transforming the light into incoherent or quasi-coherent light.

15. The method of claim 10, further comprising inputting light having a plurality of different wavelengths.
